(19) United States
(12) Patent Application Publication
(10) Pub. No.: US 2026/0362097 A1
(43) Pub. Date: Nov. 12, 2026

(54) METHODS, ARCHITECTURES, APPARATUSES, AND SYSTEMS FOR DYNAMIC SENSING MODE AND TOPOLOGY SELECTION

(71) Applicant: InterDigital Patent Holdings, Inc., Wilmington, DE (US)

(72) Inventors: Magurawalage Chathura Madhusanka Sarathchandra, London (GB); Jung Je Son, Warrington, PA (US); Zhibi Wang, Woodridge, IL (US); Laksh Bhatia, London (GB); Alain Mourad, Ascot (GB); Carlos Jesus Bernardos, Madrid (ES); Muhammad Awais Jadoon, London (GB); Sebastian Robitzsch, London (GB)

(21) Appl. No.: 19/202,966

(22) Filed: May 8, 2025

(51) Int. Cl. H04W 4/38; H04W 8/22; H04W 24/08

(52) U.S. Cl. CPC H04W 4/38; H04W 8/22; H04W 24/08

(57) ABSTRACT

Procedures, methods, architectures, apparatuses, systems, devices, and computer program products are provided for dynamically changing a sensing profile. The methods and systems include a WTRU receiving, from a wireless network, a first sensing profile, a second sensing profile, and sensing capability monitoring information. The methods and systems also include performing a sensing task based on the first sensing profile. The methods and systems additionally include determining a change in sensing capability based on the sensing capability monitoring information while performing the sensing task. The methods and systems furthermore include, based on determining the change in the sensing capability, reporting, to the wireless network, sensing capability information and configuring the WTRU based on the second sensing profile.

### TECHNICAL FIELD

The present disclosure is generally directed to the fields of communications, software and encoding/decoding, including, for example, to methods, architectures, apparatuses, and systems related to dynamically switching a sensing mode at a sensing entity and sensing topology.

### BACKGROUND

A sensing entity may be configured to perform a particular type of sensing for a particular sensing environment. However, changes in the sensing environment can negatively impact sensing performance.

### SUMMARY

A wireless transmit/receive unit (WTRU), or any suitable sensing entity, may be configured to perform a sensing task under a sensing configuration. The sensing configuration may indicate or correspond to a sensing mode (e.g., monostatic, bi-static, or multi-static sensing) and a sensing topology (e.g., a configuration indicating what sensing entities are to participate in a sensing task). If there are changes in the environment of a sensing target, changes in the functionality that the WTRU may provide, or changes in the requirements of the given sensing task, then it may be suitable to dynamically change the sensing configuration that a WTRU is currently operating under. Accordingly, systems and methods are desired for dynamically changing a sensing configuration at a WTRU.

In accordance with certain representative embodiments of the present disclosure, methods and systems are provided for operating a WTRU. The methods include a WTRU receiving, from a wireless network, a first sensing profile, a second sensing profile, and sensing capability monitoring information. In certain representative embodiments, the first sensing profile is associated with a first sensing configuration, where the first sensing configuration includes a monostatic configuration, a bi-static configuration, or a multi-static configuration. The second sensing profile is associated with a second sensing configuration that is different from the first sensing configuration. In certain representative embodiments, the first sensing profile is associated with a first quality of service, and the second sensing profile is associated with a second quality of service. In certain representative embodiments, the second sensing profile may include an indication to terminate the sensing task or an indication to perform a different sensing task. The methods also include performing a sensing task based on the first sensing profile. The methods additionally include determining a change in sensing capability based on the sensing capability monitoring information while performing the sensing task. The methods furthermore include, based on determining the change in the sensing capability, reporting, to the wireless network, sensing capability information and configuring the WTRU based on the second sensing profile.

In certain representative embodiments, the sensing capability monitoring information indicates a sensing profile switch condition. The methods moreover include, based on determining that the sensing profile switch condition is satisfied, selecting the second sensing profile for performing the sensing task.

In certain representative embodiments, configuring the WTRU based on the second profile is based on receiving, from the wireless network, an indication to select the second sensing profile for performing the sensing task.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals ("ref.") in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 1E is an illustrative block diagram of components implementing the features of a sensing network function, in accordance with certain embodiments;

FIG. 2 is an illustrative reference model of a wireless network with which a UE communicates, in accordance with certain embodiments;

FIG. 3 illustrates an example of a pedestrian and/or animal intrusion detection, in accordance with certain embodiments;

FIG. 4 illustrates an example of intruder detection in surroundings of a smart home, in accordance with certain embodiments;

FIG. 5A illustrates an example of a multiple access channel with mono-static base station sensing, in accordance with certain embodiments;

FIG. 5B illustrates an example of a multiple access channel with bi-static base station sensing, in accordance with certain embodiments;

FIG. 6 is a diagram illustrating how the quality of sensing measurements may change due to obstacles, in accordance with certain embodiments;

FIG. 7 is a diagram illustrating how multiple base stations may be configured to improve sensing accuracy and sensing service continuity in a given sensing task, in accordance with certain embodiments;

FIG. 8 is a set of diagrams illustrating the differences between monostatic, bi-static, and multi-static sensing, in accordance with certain embodiments;

FIG. 9 is a diagram illustrating a procedure for how changes in sensing capability may be dynamically reported to a wireless network, in accordance with certain embodiments;

FIG. 10 is a diagram illustrating how the sensing mode and sensing topology of a WTRU may be dynamically changed, in accordance with certain embodiments; and

FIG. 11 is a flowchart of an illustrative method performed by a WTRU for dynamically switching a sensing profile, in accordance with certain embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively "provided") herein. Although various embodiments are described and/or claimed herein in which an apparatus, system, device, or any suitable combination thereof and/or any element thereof carries out an operation, process, algorithm, function, or any suitable combination thereof, and/or any portion thereof, it is to be understood that any embodiments described and/or claimed herein assume that any apparatus, system, device, or any suitable combination thereof and/or any element thereof is configured to carry out any operation, process, algorithm, function, or any suitable combination thereof and/or any portion thereof.

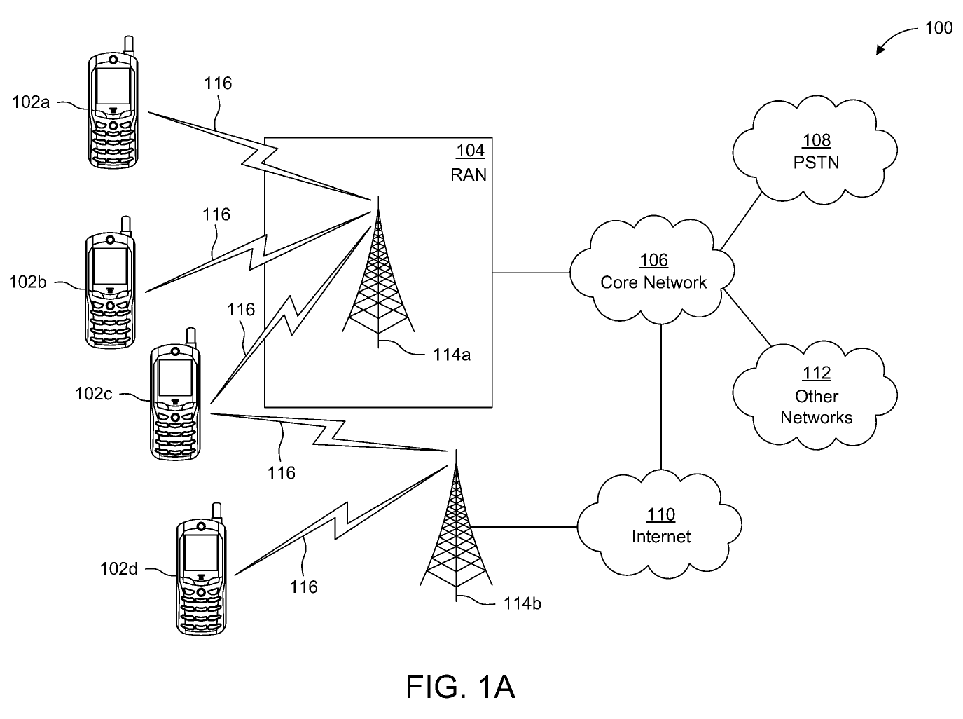

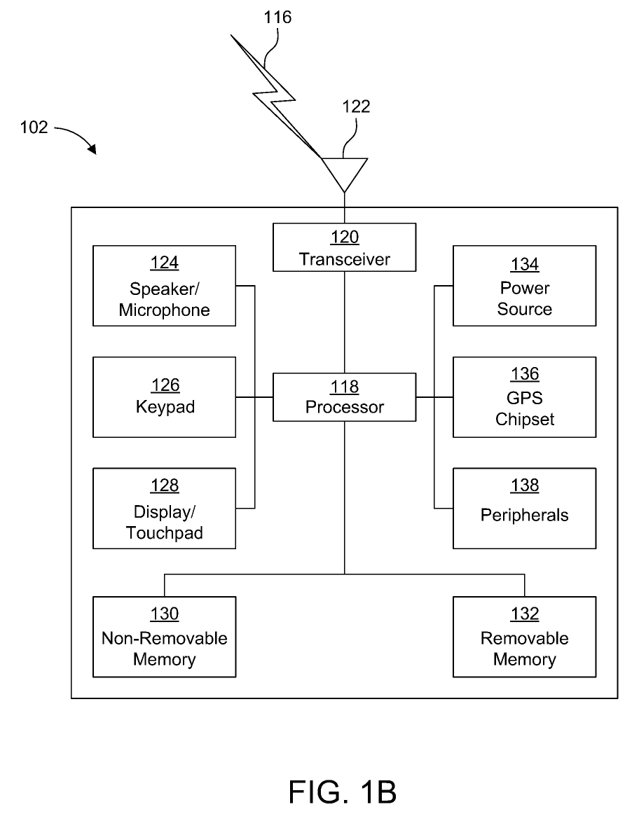

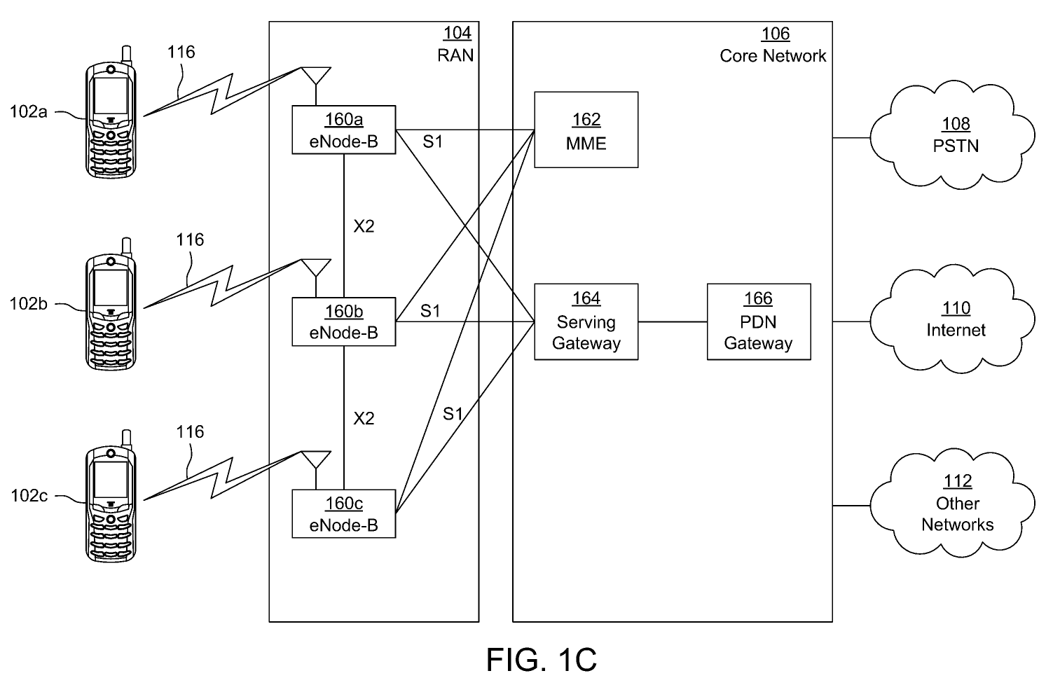

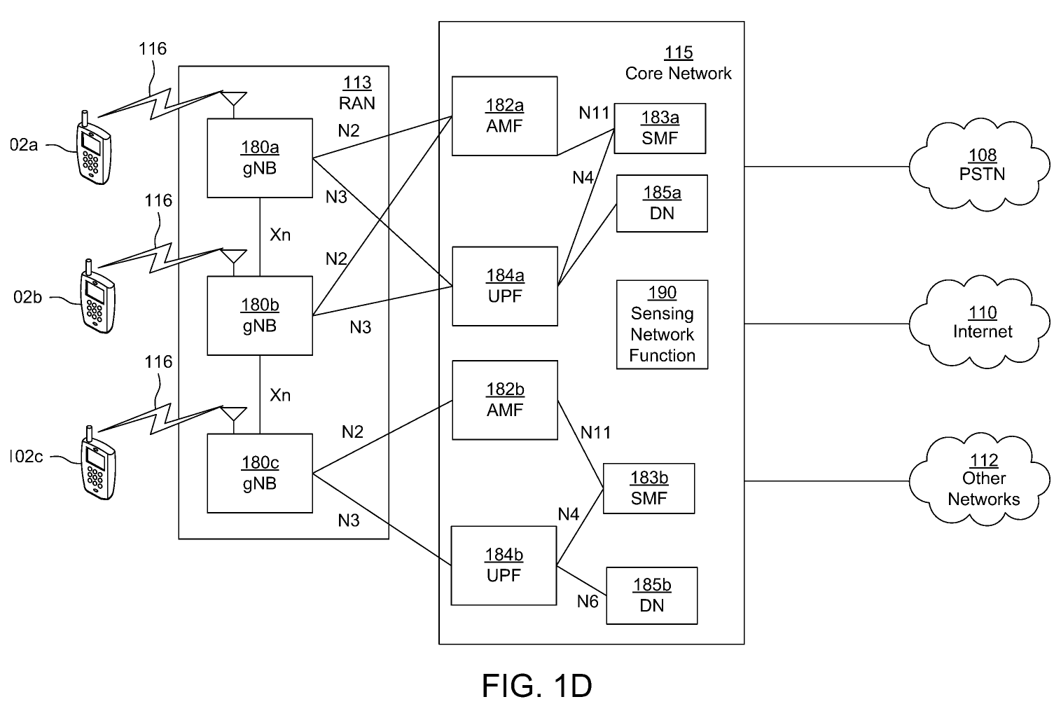

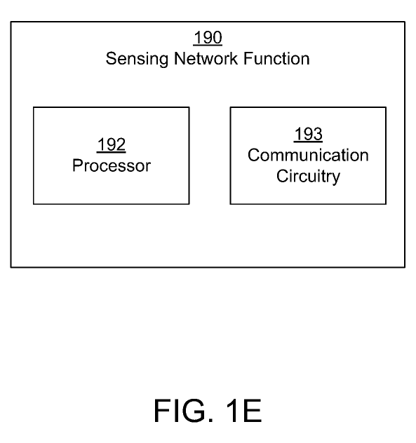

The methods, apparatuses and systems provided herein are well-suited for communications involving both wired and wireless networks. An overview of various types of wireless devices and infrastructure is provided with respect to FIGS. 1A-1E, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, or any suitable combination thereof, to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a "station" and/or a "STA", may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNB, a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

It will be understood that a wireless network may include any suitable components and devices, including, for example, any of one or more base stations, one or more TRPs, one or more gNBs, one or more WTRUs, any network functions, one or more RANs, one or more application functions, one or more access and mobility management functions (AMFs), any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

The base station 114a may be part of the RAN 104/113, which may also include other base stations and/or network elements (not shown), such as a base station controller (BSC), a radio network controller (RNC), relay nodes, or any suitable combination thereof. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, or any suitable combination thereof). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, or any suitable combination thereof) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, or any suitable combination thereof, and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), or any suitable combination thereof), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an "ad-hoc" mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, or any suitable combination thereof.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards AMFs 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, at least one Data Network (DN) 185a, 185b, and at least one sensing network function 190. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

FIG. 1E is an illustrative block diagram of components implementing the features of a sensing network function, in accordance with certain embodiments of this disclosure. Sensing network function 190 may be embedded in current or newly defined entities of a wireless network. These functions need not be defined by their execution at a particular node of a wireless network, nor based on any other networks/devices of the wireless network with which these functions interact.

Sensing network function 190 includes at least processor 192 and communication circuitry 193. The communication circuitry of FIG. 1E may be configured to receive any incoming messages and transmit any outgoing messages. The respective components shown in FIG. 1E may also include, or be coupled to, memory and any other physical components as may be needed to support the operations of the respective processors and communication circuitries.

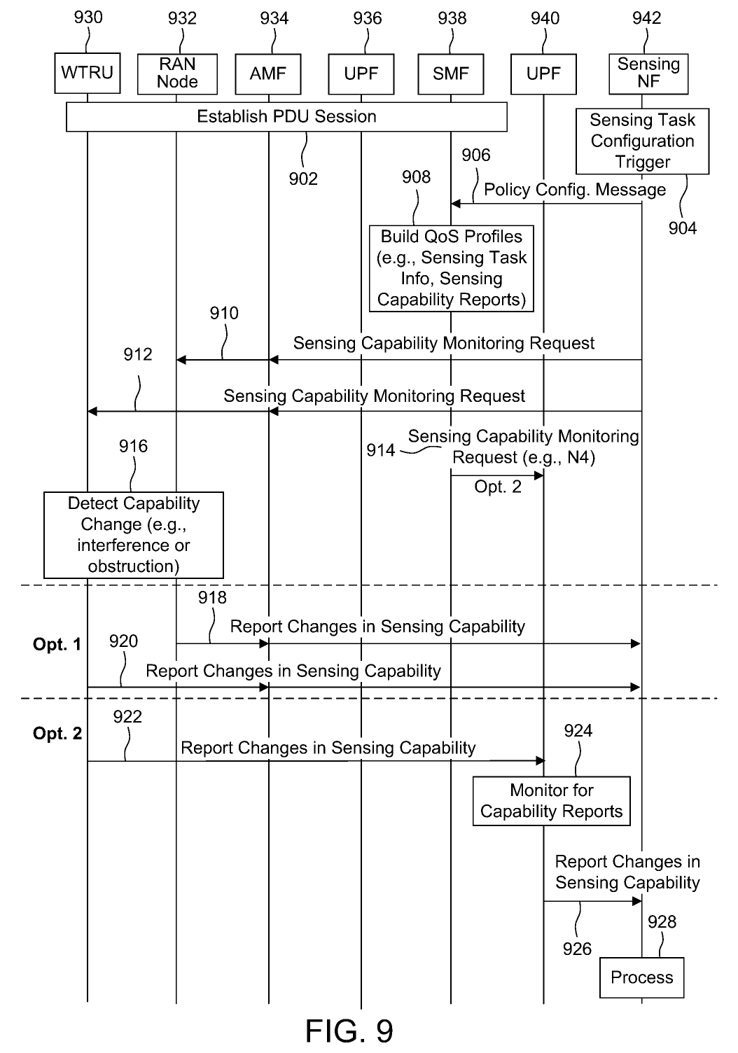

Sensing network function 190 may coordinate a sensing operation in a wireless network. This coordination may include full or partial management of sensing sources of sensing data, other sensing data, sensing results, and sensing contextual information. Sensing network function 190 may be configured to perform any tasks performed by sensing network function 942 as further described below in FIG. 9. In any suitable wireless system, there may or may not be specific functions dedicated to performing tasks that are ascribed herein to a sensing network function.

In view of FIGS. 1A-1E and the corresponding description of FIGS. 1A-1E, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, sensing network function 190, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

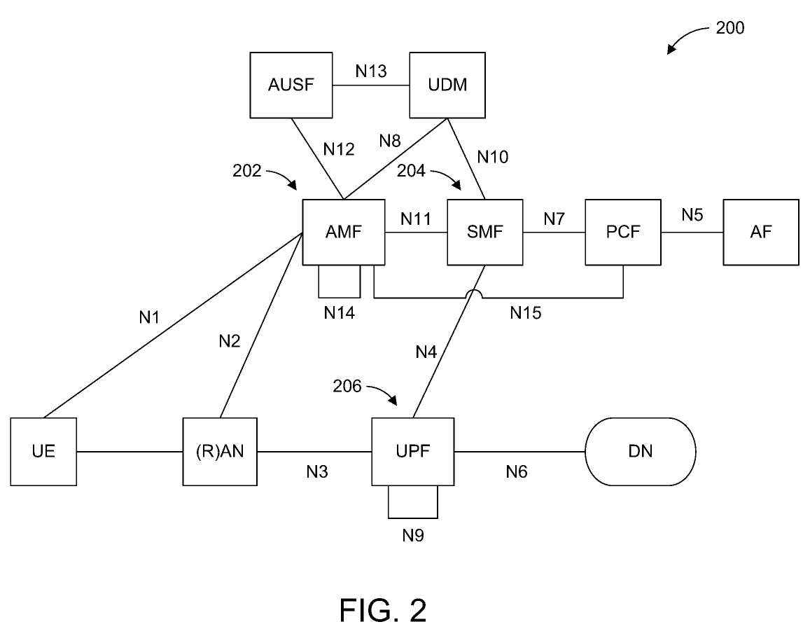

In certain embodiments of the present disclosure, including those described below at least in connection with FIGS. 2-11, the devices, systems, architectures, communication links, apparatuses, and other elements depicted in FIGS. 1A-1E may be used in connection with sensing availability evaluation of sensing entities.

In accordance with some embodiments of this disclosure, a reference model of a 5G network, or other suitable network, is shown in FIG. 2 and described as follows. FIG. 2 illustrates an example of reference model 200 of a network architecture (e.g., a 5G or NextGen network). In certain representative embodiments, AMF 202 (e.g., which may be the same as AMF 182a or 182b) includes the functionalities of registration management, connection management, reachability management, and mobility management. In certain representative embodiments, SMF 204 (e.g., which may be the same as SMF 183a or 183b) includes the functionalities of session management (e.g., session establishment, modification, and release), UE IP address allocation, selection, and control of UPFs. In certain representative embodiments, UPF 206 (e.g., which may be the same as UPF 184a or 184b) includes the functionalities of packet routing, packet forwarding, packet inspection, and traffic usage reporting.

In certain representative embodiments of this disclosure, integrated sensing capabilities and potential systems, methods, and devices for enhancing current 5G systems/standards are provided. For example, the enhancements may provide sensing services addressing different target verticals/applications (e.g., autonomous/assisted driving, vehicle-to-everything, unmanned aerial vehicles, 3D map, smart city, smart home, factories, healthcare, or maritime sector). In integrated sensing applications, there is a process of collecting sensing measurement data. The sensing measurement data, for example, may be data collected about radio/wireless signals impacted (e.g., reflected, refracted, diffracted) by an object or by an environment of interest for sensing purposes. A further example of generating sensing measurement data may be deriving sensing results from processing sensing measurement data. There may also be an area defined for sensing such as a sensing service area (SSA) location, which may be an area or location (with or without at least one obstacle) in which the SSA can provide sensing service with target quality.

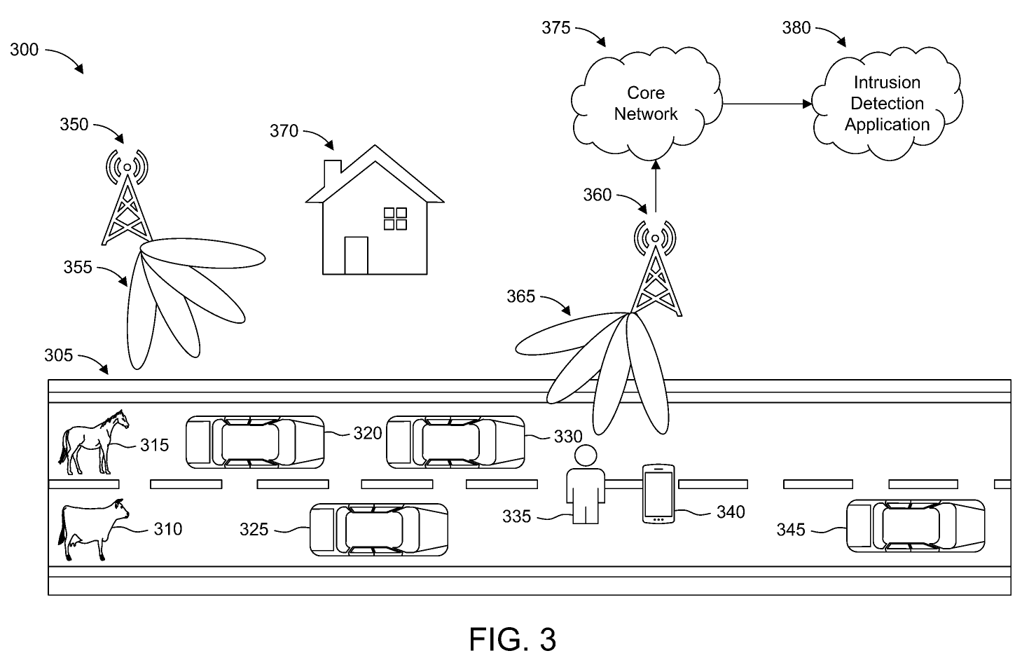

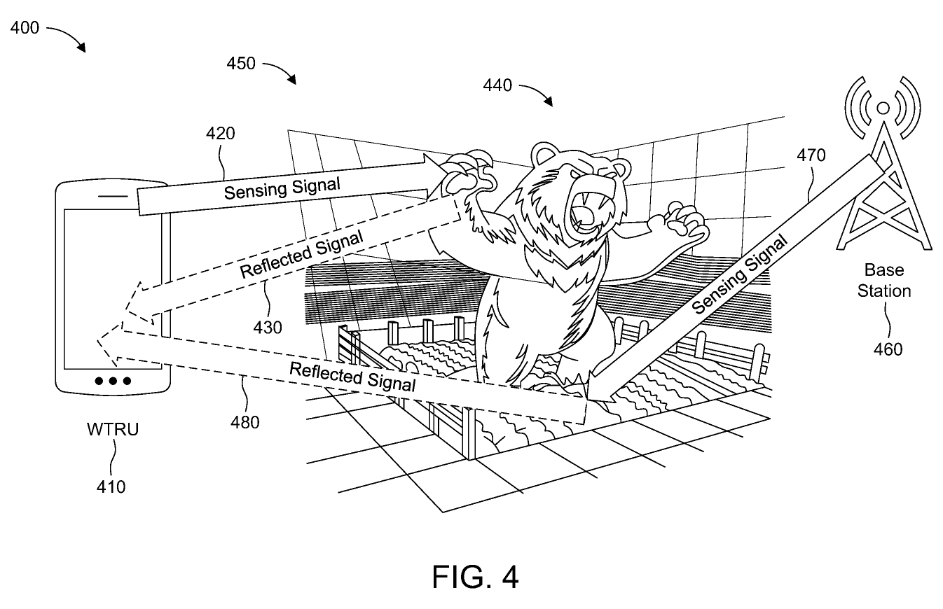

An illustrative use case for integrated sensing is object detection. For example, detection of pedestrian and/or animal intrusion detection on a highway (see, for example, FIG. 3), or detection of an intruder in surroundings of a smart home (see, for example, FIG. 4), are considered.

As shown in FIG. 3, for example, in an outdoor environment 300, pedestrian and/or animal intrusion detection is provided. Environment 300 includes highway 305 and residential property 370 adjacent to highway 305. Base station 350 (e.g., which may be the same as base station 114a or 114b) at a first location and base station 360 at a second location emit beams 355 and 365, respectively. Beams 355 and 365 interact with highway 305 and objects 310-345 on highway 305 such as first animal (e.g., cow) 310, second animal (e.g., horse) 315, first vehicle 320 traveling in a first direction (right-to-left on the page), second vehicle 325 traveling in a second direction (left-to-right) opposite the first direction, third vehicle 330 traveling in the first direction, pedestrian 335 traveling in the first direction, the pedestrian 335 carrying a WTRU 340 (e.g., which may be the same as WTRU 102a, 102b, 102c, or 102d), and fourth vehicle 345 traveling in the second direction. Information regarding highway 305, property 370, and objects 310-345 is transmitted by base station 360 (e.g., which may be the same as base station 114a or 114b)) to core network 375 (e.g., which may be the same as CN 106 or 115). Core network 375 transmits the information to intrusion detection application 380. Intrusion detection application 380 is configured to sense, identify, and/or track objects 310-345, for example, with respect to base stations 350, 360 and/or one or more fixed points along highway 305 and/or property 370. Intrusion detection application 380 may be configured to differentiate between different types of vehicles (e.g., compact vehicle 325 versus large vehicle 345) or different types of objects (e.g., horse 315 versus human 335) and corresponding locations, directions of movement, velocities, or the like.

As shown in FIG. 4, for example, in outdoor environment 400, intruder detection in surroundings 450 of a smart home is provided. Environment 400 includes WTRU 410 (e.g., which may be the same as WTRU 102a, 102b, 102c, 102d, or 340), intruder (e.g., a bear) 440, and base station 460. WTRU 410 is configured to transmit a sensing signal 420, which, in this example, is incident on intruder 440. WTRU 410 is configured to receive reflected signal 430, which, in this example, reflects sensing signal 420 after incidence with intruder 440. Base station 460 is configured to transmit sensing signal 470, which, in this example, is incident on surroundings (e.g., the ground) 450. WTRU 410 is configured to receive reflected signal 480, which, in this example, reflects sensing signal 470 after incidence with the surroundings 450.

In the scenarios of FIGS. 3 and 4, base station (e.g., 350, 360, 460) and/or WTRU (e.g., 340, 410) can detect the intrusion of an object (e.g., cow 310, vehicle 320, bear 440) into the sensing area of the base station by itself or by collaboration between the WTRU and the base station. For example, the sensing measurement is transferred to the core network 375 and further processed into the sensing result.

In certain embodiments, transparent sensing is another use case for integrated sensing wherein sensing data is captured by a WTRU and communicated so that 5GS is aware of the sensing information. The WTRU may acquire sensing measurements from different 3GPP and non-3GPP devices. 5GC may determine various available sensing services by processing collated sensing data.

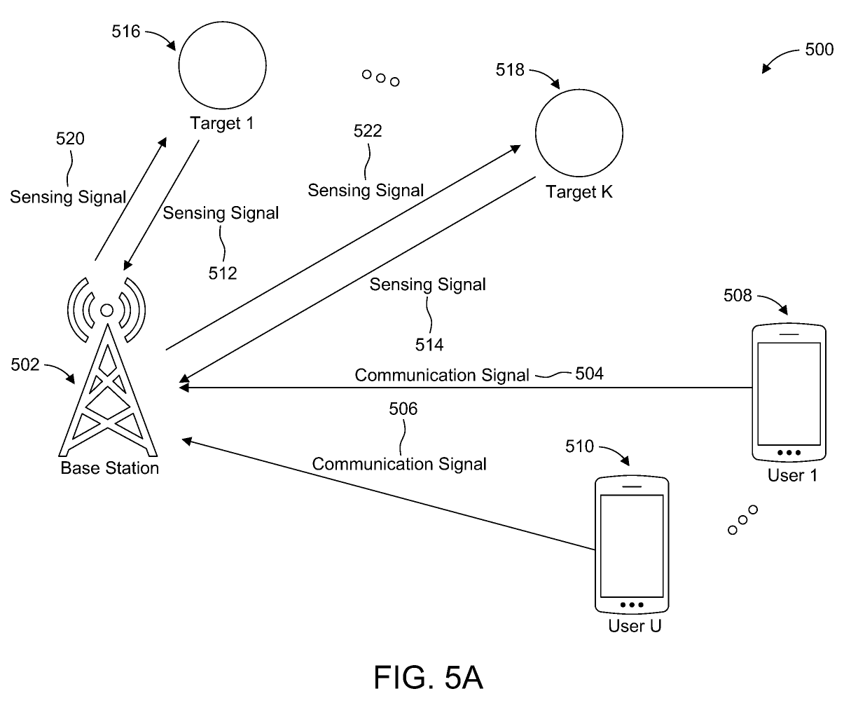

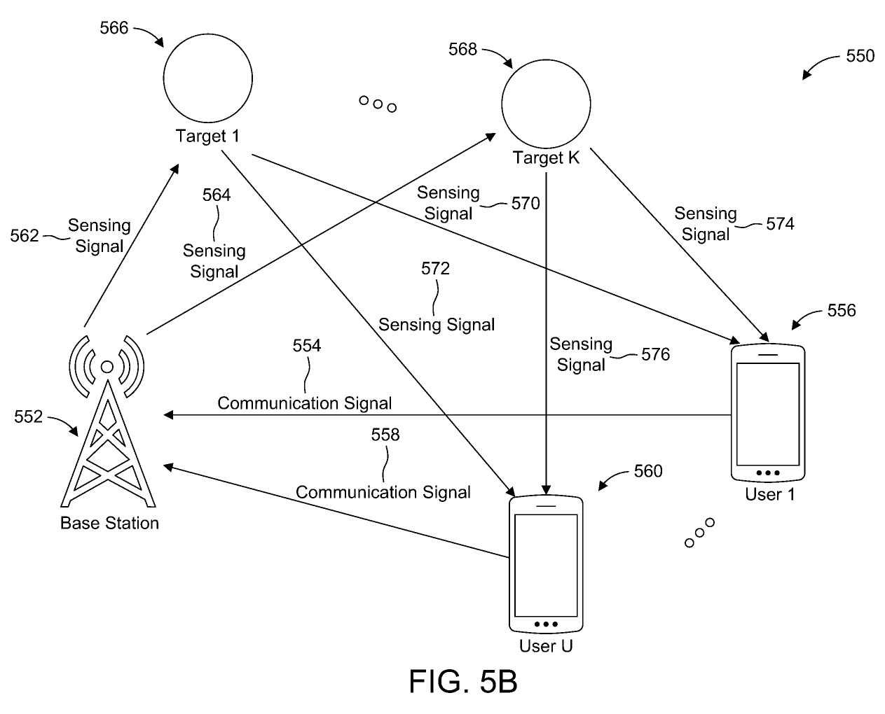

FIG. 5A illustrates an example of monostatic sensing wherein the sensing signal sender and receiver are the same node, in accordance with certain embodiments. For example, in environment 500, base station 502 (e.g., which may be the same as base station 114a, 114b, 350, 360, or 460) may send first sensing signal (e.g., sensing signal 520 or 522) and receive second sensing signal (e.g., sensing signal 512 or 514) as a reflection of the first signal. Base station 502 may also receive communication signals 504 and/or 506 from user devices 508 and 510, respectively. Communication signals 504 and/or 506 may indicate an outcome of a sensing operation, and/or may trigger a reconfiguration (e.g., including any suitable details of the reconfiguration). As shown in FIG. 5A, “K” of “Target K” and “U” of “User U” may represent any suitable integers. It will be understood that, for example, if U equals five, then there would be five respective user devices (although only two are shown for illustrative purposes). It will also be understood that, for example, if K equals three, there would be three respective targets (although only two are shown for illustrative purposes).

FIG. 5B illustrates an example of bi-static sensing wherein the sensing signal sender and sensing signal receiver are two different nodes, in accordance with certain embodiments. For example, in environment 550, base station 552 (e.g., which may be the same as base station 114a, 114b, or 502) may receive a communication signal 554 from user device 556 and receive communication signal 558 from user device 560. The base station 552 may also send first sensing signals 562 and 564 to targets 566 and 568, respectively. A target may reflect a first sensing signal to generate a second sensing signal (e.g., sensing signal 570 or 572) that may be recorded at a user device receiving the sensing signal. TAs shown in FIG. 5B, “K” of “Target K” and “U” of “User U” may represent any suitable integers. It will be understood that, for example, if U equals five, then there would be five respective user devices although only two are shown. It will also be understood that, for example, if K equals three, there would be three respective targets although only two are shown.

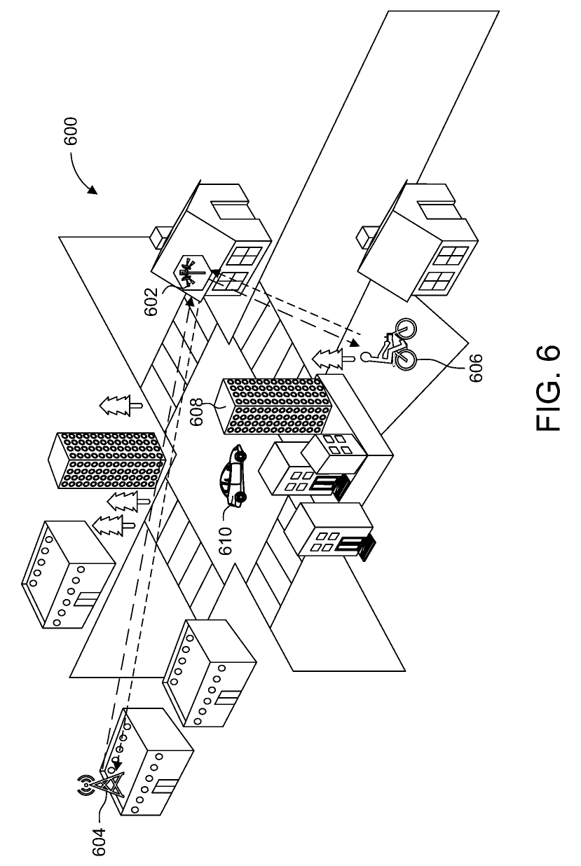

FIG. 6 is a diagram illustrating how the quality of sensing measurements may change due to obstacles, in accordance with certain embodiments.

In diagram 600, sensing entity 602 (e.g., which may correspond to any of WTRUs 102a-102d, 340, 410, 508, 510, 556, or 560) may be in communication with base station 604 (e.g., which may correspond to any one or more of gNBs 180a-180c or base stations 350 460, 502, or 552). Sensing entity 602 may also be referred to as WTRU 602. Sensing entity 602 may be configured to perform one or more sensing measurements on sensing target 606. Obstacles, such as building 608 or car 610, may block the transmission of signals needed to perform a sensing task. As such, the availability and accuracy of information related to sensing target 606 may be negatively impacted. It may be desirable to consider how a 5G system may be configured to minimize the negative effects of obstacles in terms of the collected sensing information; it may also be desirable to select suitable sensing entities that may provide more accurate results after considering obstacles in a sensing environment.

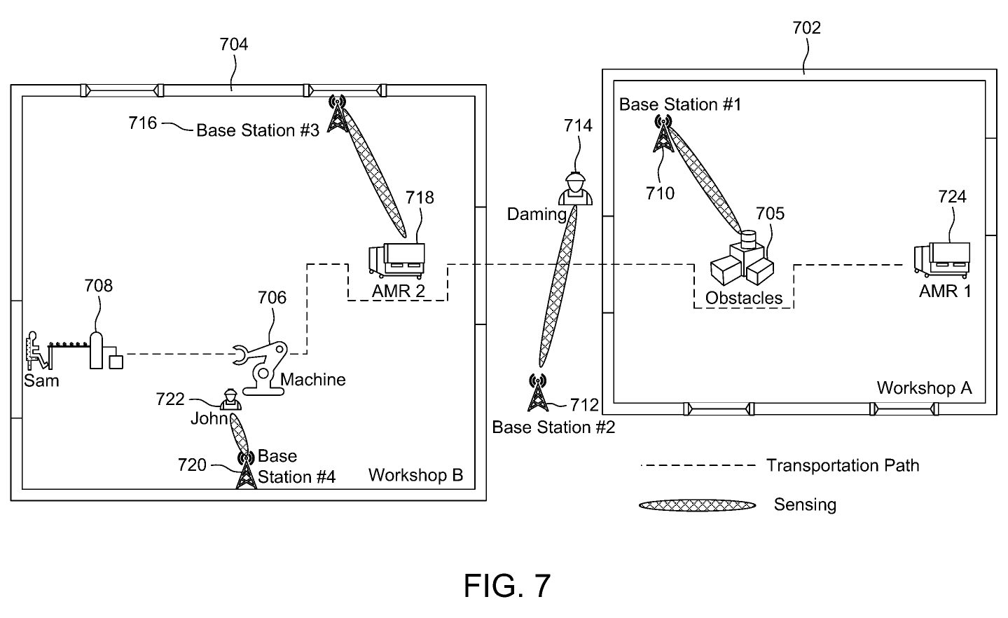

FIG. 7 is a diagram illustrating how multiple base stations may be configured to improve sensing accuracy and sensing service continuity in a given sensing task, in accordance with certain embodiments.

In diagram 700, a sensing environment may include warehouse 702 and warehouse 704. There may be obstacles in the sensing environment such as objects 705, 706, or 708. To minimize the impact of these obstacles on a sensing task, such as a task configured to provide information indicative of a path that autonomous mobile robot (AMR) 724 may take, different base stations may be associated with different sensing objects. For example, base station 710 may be associated with object 705, base station 712 may be associated with person 714, base station 716 may be associated with AMR 718, and base station 720 may be associated with person 722. Information from base stations 710, 712, 716, and 720 may provide more accurate and continuous sensing data compared to the use of a single base station, allowing AMR 724 to smoothly navigate a transportation path. Any one of base stations 710, 712, 716, or 720 may correspond to any one or more of gNBs 180a-180c or base stations 350 460, 502, 552 or 604.

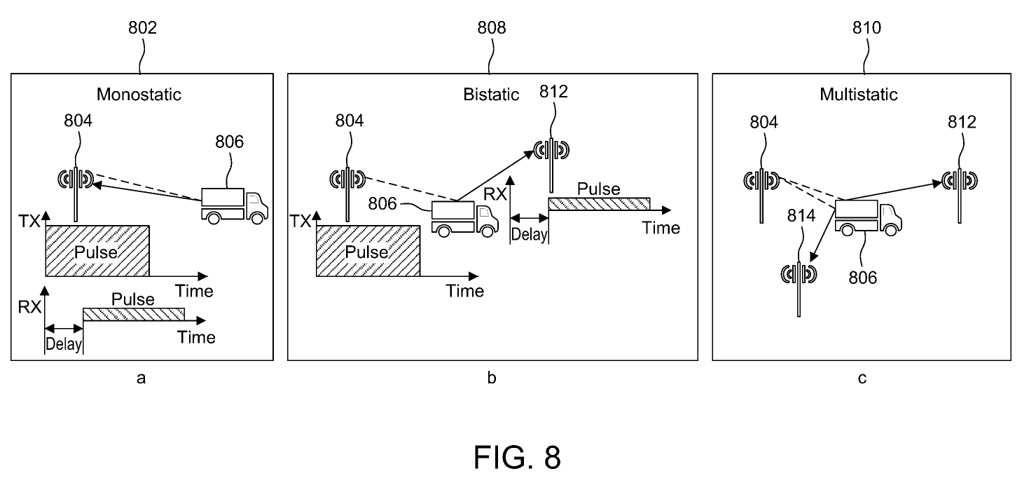

FIG. 8 is a set of diagrams illustrating the differences between monostatic, bi-static, and multi-static sensing, in accordance with certain embodiments.

Monostatic diagram 802 illustrates how a monostatic sensing task may occur. In monostatic sensing, a transmitter and receiver are co-located. For example, there may be a single TRP (e.g., TRP 804) configured to perform sensing on sensing target 806. There may be significant self-interference in sensing tasks with monostatic sensing topologies. If sensing target 806 is designed to minimize backscatter by reflecting radar energy in various directions, sensing measurements associated with sensing target 806 may be more inaccurate if a monostatic architecture is used compared to a bi-static architecture. Monostatic architectures, however, are less resource and coordination intensive than bi-static architectures.

Bi-static diagram 808 and multi-static diagram 810 illustrate how a bi-static and multi-static sensing task may occur, respectively. For example, in bi-static sensing, TRP 804 may act as a transmitter and TRP 812 may act as a receiver. For example, in multi-static sensing, TRP 804 may act as a transmitter and TRPs 814 and 812 may act as receivers. Bi-static and multi-static architectures are typically suitable for sensing targets with low observability. Bi-static and multi-static architectures are more flexible than monostatic architectures because sensing capabilities are not limited to a single node. Bi-static and multi-static architectures are typically more resource and coordination intensive than monostatic architectures. For example, synchronization may be required between separated nodes (e.g., between TRPs 804, 812, and 814) in multiple dimensions such as time, frequency, and phase.

In this disclosure, sensing features may refer to physical features or properties of a sensing target that may be extracted from sensing data. The sensing features sensed by a sensor node may change depending on various factors that are related to the sensing target, its surrounding environment, and the sensor transmitter and receiver. For example, the location of a sensing transmitter or receiver in relation to the sensing target and the radio frequency of use for sensing by the transmitter may influence which physical parts of the sensed object are visible to the sensor. Such aspects may further or instead influence the resolution and accuracy of a sensing task. Such aspects may further or instead include which physical parts of the sensed objects are hidden to the sensor. As such, not all features of the sensing target object may be obtained depending on the configuration of the sensing transmitter and receiver, the context of the target object, and the sensing environment.

Furthermore, the type of sensing data captured may be dependent on the capabilities of the respective sensing entity. For example, two sensing entities may be placed in identical locations in relation to the target object. The first sensing entity may be a radio sensor which may accurately sense the materials used on the surface of the target object. The second sensing entity may be a light detection and ranging (LiDAR) sensor which may accurately sense the relative distance between the second sensing entity and the target object. Sensing entities at different locations may be configured to provide a 360 degree view of a target object, and different sensing entities may capture different types of data regarding the target object.

In certain representative embodiments, an AF may request QoS monitoring parameters to trigger QoS monitoring for service data flows. QoS monitoring for an available bitrate allows the measurement and reporting of an uplink and downlink for a guaranteed bit rate (GBR) QoS flow without alternative QoS profiles at an NG-RAN. An available bitrate refers to the bitrate that an NG-RAN is able to provide for a QoS flow within a duration. The duration is based on RAN implementation.

In certain representative embodiments, an SMF may configure a PDU session anchor (PSA) UPF to perform QoS monitoring for an available bitrate. For the reporting of the available bitrate via the PSA UPF, only event-based reporting applies in the PSA UPF. The reporting thresholds in the policy and charging control (PCC) rule need not be sent to a UPF. At a UPF, the event for the reporting is the reception of available bitrate information from an NG-RAN. Based on the QoS monitoring request for the available bitrate from the SMF, the PSA UPF monitors and exposes the available bitrate information reported from NG-RAN to the target NF as instructed. An NG-RAN may report the uplink and downlink available bitrate information of the highest fulfilled threshold to the PSA UPF via a general packet radio service tunneling protocol-uplink (GTP-U) header of uplink packets.

In certain representative embodiments, alternate QoS profiles (AQP) may increase flexibility in service QoS treatment. An AQP may allow service continuity and optimization while adapting to various conditions such as congestion or policy changes. AQPs may be associated with a QoS flow and defined in addition to a standard or default QoS profile. Conditions for when an AQP may be used include any one or more of congestion situations, subscription changes, or when specific policies (e.g., dictated by a UE route selection policy) are triggered. An AQP may indicate any one or more of QoS parameters, packet delay budget, packet error rate, averaging window, or GFB information to which application traffic may be able to adapt to. An AQP may be optionally provided for a GBR QoS flow with notification control enabled. An SMF may provide a prioritized list of AQPs, in addition to QoS profiles, to an NG-RAN.

As such, it may be desirable to provide methods and systems for detecting changes in available sensing capabilities overtime and adapting a sensing configuration (e.g., specifying a sensing mode and sensing topology) based on said detected changes.

In certain representative embodiments, there may be a tradeoff between a level of complexity, capability usage, and performance characteristics of ISAC systems. As previously described above in connection with FIG. 8, monostatic sensing is simpler and requires less capabilities. However, in some scenarios, monostatic sensing may be less performant (e.g., potential self-interference issues and less accuracy). Bi-static or multi-static topologies may require more coordination and more capabilities but may be more performant than monostatic topologies.

In certain representative embodiments, sensing performance depends on the sensing mode (e.g., monostatic, bi-static, or multi-static) in use and the nodes (i.e., transmitters and receivers) involved. Changes in the sensing environment of the target object (e.g. mobility, appearance or disappearance of environmental objects) in addition to changes in the capabilities and configurations of the sensing nodes may affect sensing performance. Changes in sensing performance may be a trigger for the wireless network to make updates to sensing mode and the nodes involved to achieve the best trade-off between sensing performance and the use of resources. Capability availability, complexity of a sensing task, or changes in the sensing target environment may be considered when an updates sensing mode is determined as further described below.

Regarding capability availability, if more capabilities become available in a suitable sensing entity, switching the topology from monostatic to bi-static in order to incorporate newly available capabilities may result in improved sensing performance and less interference. Regarding the complexity of a sensing task, part of a sensing task may involve sensing a surface that minimizes backscatter by reflecting radar signals in other directions. As such, it may be suitable to switch from a monostatic topology to a bi-static or multi-static topology in order to meet sensing performance requirements. Regarding changes in the sensing environment, the mobility of the sensing target involved or the sudden appearance of environmental objects in the vicinity of sensing entities may lead to changes in sensing performance. Detriments of such changes may be ameliorated by switching to another sensing mode involving existing or other nodes, increasing the usage of resources towards a better performance-cost tradeoff, or any suitable action.

As such, if factors such as capability availability, complexity of a sensing task, or changes in the sensing target environment are not considered or if an underlying configuration of a sensing task is not changed to adapt to the aforementioned factors, sensing performance information may be suboptimal. Furthermore, failure to consider such factors may result in inefficient use in resources (e.g., under or over utilized resources) and poor sensing QoS. Moreover, in some implementations, procedures for user plane capability reporting may only enable sensing entities to report data transmission capability information (e.g., a rate at which data is reported) to an NF. As such, it may be desirable to report sensing capability information to an NF in addition to data transmission capability information. Additionally, it may be desirable for other sensing entities to monitor and include sensing capability information from other sensing entities before sending sensing capability information to the wireless network.

In accordance with certain representative embodiments of the present disclosure, methods and systems are provided for allowing a wireless network to receive information indicative of updated or changed capabilities in sensing entities. Such information may be sent via control plane NAS signaling or over via user plane. Sensing entities may also act as aggregators, processors, samplers, or multiplexers of sensing capability information. Furthermore, methods and systems are provided for allowing a sensing entity to switch its sensing topology and sensing mode based on any one or more of the following types of information: an alternative sensing performance profile (e.g., indicative of different acceptable sensing performance), a switching profile (e.g., one or more rules indicating when to switch between different sensing topologies), or capability information (e.g., how a sensing entity should be configured based on the availability of certain capabilities). The techniques described in relation to AQPs may be used in combination with the techniques described for alternative sensing performance profiles.

In certain representative embodiments, a sensing entity (e.g., any suitable WTRU) may evaluate conditions under which it should switch to an alternative sensing performance profile. A sensing entity may configure itself under a particular sensing performance profile if the wireless network indicates that a change in sensing configuration is required.

The procedures described herein may be used for switching between sensing modes (e.g., monostatic to bi-static). Alternatively, the procedures herein may also be used for changing sensing entities involved while keeping the same sensing mode as a currently used configuration.

It will be understood that sensing topology is changed when sensing nodes that are used for a sensing task change. A sensing mode may be switched while keeping the same sensing topology and keeping the same sensing entities for a sensing task. It will be understood that hardware and software functionalities may be referred to as a capability or resource.

In certain representative embodiments, sensing capability reporting and mode switching may be enabled when an NF performs any one or more of the following: detects that sensing requirements are not met where capability reporting is not enabled (e.g., for reducing network traffic); determines that sensing capability reporting is to be enabled (e.g., according to policy information); receives a notification from another NF (e.g., a network data analytics function) that sensing services are to be enabled to improve communication services; or determining by itself that sensing services are to be enabled to improve communication services. Similar to how AQPs are designed to provide flexibility in QoS treatment of traffic and adapt to various network conditions, alternative sensing performance profiles introduced herein may be used where multiple sensing performance profiles define how sensing parameters are to be adapted in various sensing conditions (e.g., that may be affected by the environment, capability availability, or characteristics of the sensing signals). In certain representative embodiments, in scenarios where a sensing task is associated with a PDU session, alternative sensing performance profiles may be applied as different QoS flows or as an association to different QoS parameters per profile to a QoS flow.

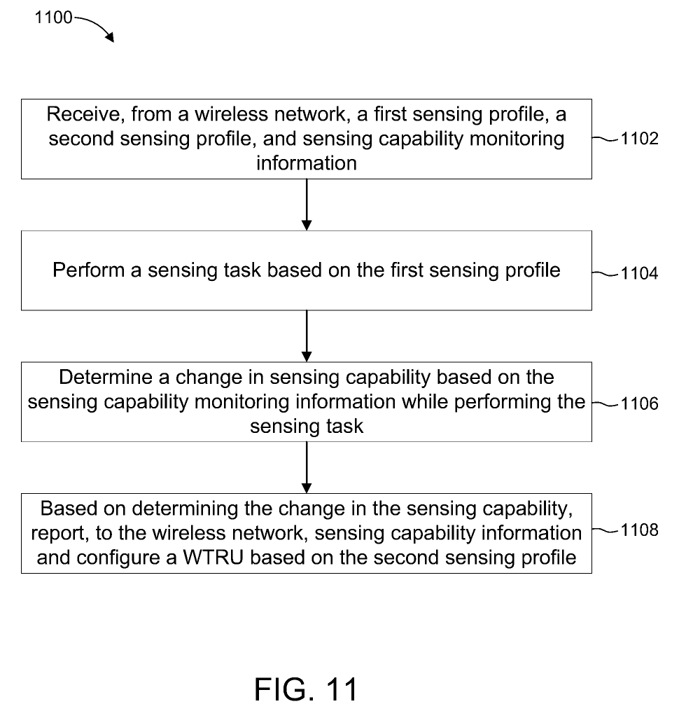

In certain representative embodiments, a WTRU may receive, from the wireless network, information indicative of any one or more of the following: instructions for how sensing related information is to be reported to the network (e.g., via control plane or via user plane); information indicating one or more changes the WTRU is to monitor (e.g., whether the WTRU is to monitor changes in available hardware functionality); instructions indicating how the WTRU should be configured based on a change in sensing capability (e.g., conditions for when the WTRU is to switch from monostatic to bi-static sensing); or what types of sensing capability information the WTRU is to report to the wireless network (e.g., information indicative of types of sensing the WTRU is able to perform). Such received information may interchangeably be referred to as a capability update report, sensing capability update report, or sensing capability monitoring information (e.g., as further describe below in connection with FIG. 11).

In certain representative embodiments, a capability update report may indicate that a particular sensing entity may be configured to perform any one or more of the following: send the capability update report to a specific network entity; use the control plane to send the capability update report (e.g., if the sensing entity acts acting as an intermediate node, it may send reports received from other sensing entities over an N2 interface) to the wireless network; use the user plane to send the capability update report (e.g., via a UPF) to the wireless network; use thresholds for determining what types of information is to be sent to the wireless network (e.g., information may indicate that the capability update report is to include information regarding two sensing entities) or use thresholds for determining when information is to be sent to the wireless network (e.g., information may indicate that information should only be sent if certain hardware is available).

In certain representative embodiments, a capability update report may indicate how reports are to be sent to the wireless network. For example, if a sensing entity is a WTRU, the capability update report may indicate to use N1, or any suitable interface, to send reports to the wireless network using the control plane. The capability update report may indicate to use enhanced radio resource control (RCC) signaling to send sensing capability reports to an NG-RAN node. The capability report may indicate to include sensing capability information. The capability update report may indicate that a specific QoS flow is to be used to send reports over the user plane to the wireless network. The capability update report may indicate that a specific bearer is to be used to send reports to the wireless network. For example, if a sensing entity is specifically an NG-RAN node, the capability update report may indicate to use N2, or any suitable interface, to send reports the wireless network over the control plane via an AMF. The capability update report may indicate to use a service based interface if a RAN node is authorized to communicate with service based interfaces of another NF. If the capability update report is send as IP traffic, the report update may indicate a configuration to be used for sending traffic and configuration information regarding a sensing target.

In certain representative embodiments, the capability update report may indicate that a sensing entity is configured to monitor and include any one or more of the following as information to the wireless network: capability type (e.g., specifying that radio sensing capability based on unused or available sensing frequencies may be monitored and reported); whether the sensing entity can be configured to act as a transmitter; whether the sensing entity can be configured to act as a receiver; information related to data transmission availability for transmitting sensing data; information related to how long capabilities may be used for a sensing task; supported sensing modes; whether dynamic mode switching is supported; or conditions that affect the characteristics of the sensing data or the quality of sensing data (e.g., a line of sight condition).

In certain representative embodiments, a capability update report may indicate aggregation, multiplexing and sampling configuration information. For example, capability update report may indicate how reports are to be processed before being sent to the wireless network such as a number of reports to be included as a single report.

In certain representative embodiments, a sensing entity may receive one or more alternative sensing performance profiles which may include a preferred sensing performance profile. It will be understood that the terms sensing performance profile, sensing profile, sensing configuration, or sensing configuration information may be used interchangeably herein. Sensing performance profiles that are not the preferred sensing performance profile may be associated with a preference value. Multiple sensing performance profiles may define how a sensing QoS requirement should be adapted when a sensing entity evaluates a condition under which said sensing entity should change to an alternative sensing performance profile or when the sensing entity receives an indication from the wireless network that a change is required. A change in sensing performance profile may be instantiated based on task-wide performance related information. Furthermore, a sensing performance profile may be changed at a particular sensing entity, may be effective only within the scope of said sensing entity, or may only be associated with the performance of said sensing entity.

In certain representative embodiments, a sensing performance profile may be associated with a specific sensing mode (e.g., monostatic or bi-static); a specific environmental condition (e.g., for moving objects or weather conditions); a specific network condition (e.g., interference in the air interface, congestion, or a line of sight condition); a sensing quality (e.g., a specific resolution); or characteristics associated with sensing data (e.g., accuracy, size, or precision, latency). For example, in a smart factory use case where a robot is performing certain tasks, certain tasks may be tied to certain sensing performance profiles. If the robot is moving, holistic data may be suitable to localize and track the robot. If the robot is drilling a hole or moving a rod, more precise data may be suitable. As such different sensing performance profiles may be associated with different subtasks.

FIG. 9 is a diagram illustrating a procedure for how changes in sensing capability may be dynamically reported to a wireless network, in accordance with certain embodiments. Such a procedure is shown in diagram 900.

At 902, a PDU session may be established in certain representative embodiments where a sensing operation is associated with a PDU session. At 902, WTRU 930 (e.g., which may correspond to any of WTRUs 102-102d, 340, 410, 508, 510, 556, 560, or 602) may set up a PDU session including sensing capability update reports. At 902, WTRU 930 may receive, in a PDU session acceptance message, parameters required for sending reports. Likewise, at 902, NG-RAN node 932 may be configured with parameters required for sending reports, For example, parameters may include protocol configuration options with IP address information related to a target NF such as sensing NF 942.

At 904, sensing NF 942 determines that certain sensing entities may be configured to send update reports on their capabilities. 904 may be triggered by any one or more of the following events: receiving a sensing request from any suitable AF or a NF; determining that an existing sensing task is to be updated based on resource availability (e.g., a switching strategy may indicate that extra sensing entities are to be added to an ongoing sensing task before switching the sensing mode to bi-static or multi-static sensing); policy information indicating that sensing capability update reports are be enabled; or knowledge of newly available sensing entities.

At 906, in cases where reports are sent over a user plane, SMF 938 receives a message indicating that a PDU session for sensing capability update reports is to be established with configuration or capability update reports. A server address or threshold information may be included in the PDU session establishment accept as protocol configuration option parameters.

In certain representative embodiments, such a message received at 906 may be received from a PCF, with policy information, indicating that capability update reports are to be enabled.

At 908, in cases where reports are sent over a user plane, SMF 938 builds sensing profiles which may at least include sensing configuration information, QoS rules, QoS profiles, or sensing capability monitoring information.

At 910, one or more NG-RAN nodes, such as RAN node 932, that are determined to be configured with capability update reports receive sensing profiles from sensing NF 942.

At 912, WTRUs, such as WTRU 930, that are determined to be configured with capability update reports receive sensing profiles from sensing NF 942.

In cases where reports are sent via the UPF, such reports may include QoS profiles that include sensing capability monitoring information.

At 914, UPF 940 may be configured to monitor and receive reports that may be associated with a traffic descriptor, a Traffic Flow Template (TFT), packet filer or rules that may be associated with reports that may be received from WTRU 930. UPF 940 may be configured to send the received capability update reports to a suitable corresponding NF such as SMF 938. The functionality provided by UPF 940 may be provided by UPF 936 and vice versa.

At 916, based on the sensing monitoring and reporting configuration, sensing entities (e.g., WTRU 930 or RAN node 932) monitor and detect one or more changes in sensing capabilities. If one or more changes in sensing capabilities are detected, the suitable sensing entity determines to send the reports over the control plane or the user plane.

In certain representative embodiments, a sensing entity may send the capability update report over the control plane to one or more suitable NFs. For example, at 918, RAN node 932 sends report updates to sensing NF 942 over the control plane. Similarly, at 920, WTRU 930 sends report updates to sensing NF 942 over the control plane.

In certain representative embodiments, at 918 and at 920, the suitable sensing entity determines what processing techniques to apply to the report (e.g., aggregation, sampling, or multiplexing), evaluates any configured thresholds (e.g., based on the configuration that a report should be send if a threshold is exceeded), determines a way in which to send the report (e.g., whether control plane is the correct way).

In certain representative embodiments, a sensing entity may send the capability update report over the user plane to one or more suitable NFs.

At 922, WTRU 922 sends the report over the user plane to UPF 940.

At 924, UPF 940 monitors incoming capability reports and receives the report from WTRU 922.

At 926, UPF 940 sends the report to sensing NF 942. UPF 940 may send the report over an established PDU session, and sensing NF 942 may review the report for updates. UPF 940 may send the report to SMF 938, and SMF 938 may send the report to sensing NF 942 for further processing.

At 928, sensing NF 942 may process the data received in the reports to determine contextual information. For example, by combining reports from multiple sensing entities, sensing NF 942 may determine, extrapolate, or predict the reason for the change considering a full context. For example, the blockage of an existing sensing entity may be due to said sensing entity physically moving. As a result, sensing transmit and receive capabilities in the sensing area may be updated.

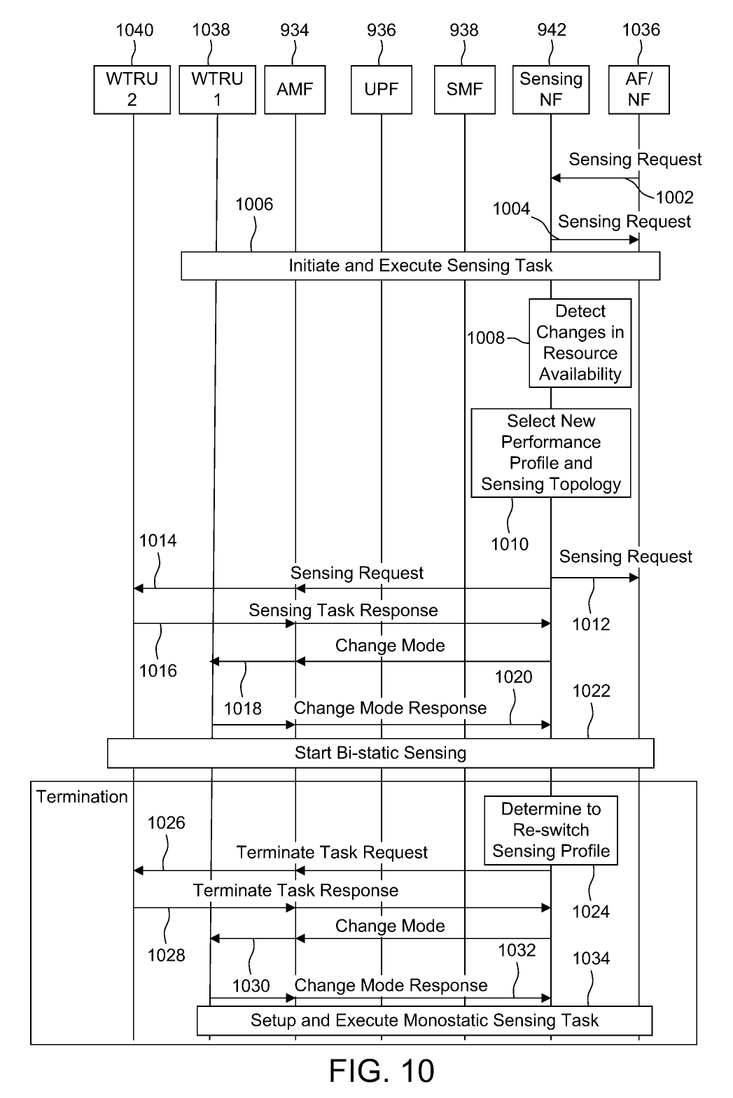

Furthermore, in accordance with certain representative embodiments of the present disclosure, methods and systems are provided for allowing a WTRU to switch its sensing mode. Switching decisions may be based on any one or more of the following: a switching strategy (e.g., information indicating suggestions on when to switch sensing mode and sensing topology); sensing resource availability; or a sensing performance profile (e.g., information indicating a QoS or any other indicator of sensing performance that is supported by a sensing service customer such as an AF or NF). Such methods and systems are further illustrated in diagram 1000 of FIG. 10.

FIG. 10 is a diagram illustrating how the sensing mode and sensing topology of a WTRU may be dynamically changed, in accordance with certain embodiments.

At 1002, NF/AF 1036 sends a message to sensing NF 942, or any suitable NF, including alternative sensing performance profiles. Such message may be a request to perform sensing. NF/AF 1036 may refer to an NF if sensing information is to be further utilized by a 5G system; NF/AF 1036 may refer to an AF in communication with a 5G system via an NEF if sensing information is to be further utilized by an application.

Alternative sensing performance profiles may provide one or more sensing performance profiles with different characteristics. A wireless network may determine to select a particular profile depending on what capabilities become available at certain WTRUs. Each sensing performance profile may be associated with a tolerance level indicating the degree to which specific quality parameters may fluctuate. For example, a first sensing performance profile may indicate that a high sensing information resolution is acceptable, and that high latency communication is acceptable. A second sensing performance profile may indicate that a low sensing information resolution is acceptable, and that high latency communication is not acceptable.

In certain representative embodiments, NF/AF 1036 may not directly provide the alternative sensing performance profiles to sensing NF 942. NF/AF 1036 may merely indicate that it supports alternative sensing performance profiles. Sensing NF 942 may in turn obtain the corresponding alternative sensing performance profiles from another NF, such as a PCF, that may be associated with a particular sensing task.

At 1004, sensing NF 942 may determine a sensing mode based on a sensing service request formed during 1002 and on information regarding the capability of known sensing entities. At 1004, sensing NF 942 may determine a sensing switching strategy based on alternative sensing performance profile information from AF/NF 1036. Furthermore, at 1004, sensing NF 942 may send a message to NF/AF 1036 indicating that the request to perform sensing was accepted.

Sensing switching strategies may indicate, for a WTRU, when to switch a sensing mode and sensing topology. Sensing switching strategies may additionally or instead indicate what sensing mode and topology to switch to after a particular event. Such indications may be considered by sensing NF 942 when a switching decision for a particular sensing mode or sensing topology is made. In other words, a sensing switching strategy may include a set of rules indicating certain conditions (e.g., for detecting a certain surface characteristic) and a set of instructions for a WTRU after once such conditions are met (e.g., an instruction to switch a sensing mode of a WTRU).

At 1006, based on the sensing mode decided by sensing NF 942, a sensing task is initiated and executed using the decided sensing mode. 1006 may be executed using any combination of 1014-1020, as further described below. Sensing entities may be configured under a sensing switching strategy (e.g., determined by sensing NF 942). WTRU 1038 (e.g., which may correspond to any of WTRUs 102-102d, 340, 410, 508, 510, 556, 560, 602, or 930) may be configured with multiple alternative sensing performance profiles and receive an indicator or index value from the wireless network based on a specific sensing switching strategy. Such indicator or index value may indicate a particular sensing mode or sensing topology to switch to. WTRU 1038 may also be configured to monitor its capabilities using a sensing resource monitoring request.

At 1008, sensing NF 942 may determine a change in sensing capability in one or more WTRUs (e.g., WTRU 1038).

At 1010, sensing NF 942 may determine a suitable sensing performance profile for one or more WTRUs (e.g., WTRU 1038). Sensing NF 942 may determine such suitable sensing performance profile based on any one or more of the following: detected changes in sensing capabilities, quality of the sensing measurements, changes in sensing signal characteristics, available alternate sensing performance profiles, or switching strategies.

In certain representative embodiments, based on changes in sensing capabilities, quality of the sensing measurements, sensing profiles, or switching strategies, sensing NF 942 may determine a sensing mode, a sensing topology, or any suitable combination thereof. Sensing NF 942 may determine new suitable sensing modes and sensing topologies. Sensing NF 942 may determine new sensing entities to be used for a given sensing task. Sensing NF 942 may decide to retain the same sensing entities currently being used for a sensing task and only change the sensing mode of said same sensing entities. For example, two sensing entities may be used initially for bistatic sensing, but sensing NF 942 may determine to change the sensing mode to monostatic for each of the two said sensing entities.

In certain representative embodiments, if alternative sensing performance profiles are to be dynamically selected at WTRU 1038, or any suitable sensing entity, sensing NF 942 may derive sensing entity node specific alternative sensing performance profiles (e.g., from the received overall alternative profiles from NF/AF 1036) to be sent to the sensing entities. These alternative sensing performance profiles may be accompanied by a switching strategy if switching at WTRU 1038 may be triggered without a message from the network. Alternatively, WTRU 1038 may select the sensing profile upon receiving an indicator or index value associated with a specific sensing performance profile from the wireless network.

At 1012, sensing NF 942 may report an indication to NF/AF 1036 of the selected sensing performance profile. Such an indication may indicate the reason behind the change. For example, a cause code may be specified that indicates the reason behind changing the sensing performance profile for WTRU 1038.

In certain representative embodiments, such an indication may only indicate that alternative sensing performance profiles are used. Based on such indication, NF/AF 1036 may anticipate that the characteristics of the sensing data may change.

At 1014 and 1016, sensing NF 942 sends new sensing requests to sensing entities that are included into the task with configuration information of the sensing task. Such configuration information may include a particular sensing topology and mode. For example, WTRU 1040 (e.g., which may correspond to any of WTRUs 102-102d, 340, 410, 508, 510, 556, 560, 602, or 930) may be added to the sensing task, and the sensing mode and sensing topology may be switched from monostatic to bi-static.

At 1014, any one or more of WTRUs 1038-1040 may be provisioned with alternative sensing performance profiles. These alternative sensing profiles may be accompanied by a switching strategy if such WTRUs may switch sensing mode and sensing topology without being triggered by a message from the wireless network. WTRUs 1038-1040 may receive indications from the wireless network indicating a particular sensing mode and sensing topology to switch to if WTRUs 1038-1040 have indications (e.g., indicators or index values) of one or more sensing performance profiles.

At 1018-1020, sensing NF 942 may configure one or more existing sensing entities (i.e., sensing entities already participating in the sensing task) with a new configuration specifying a new sensing mode or sensing topology. For example, WTRU 1038 may be configured with new sensing mode and sensing topology information. Such information may also indicate identifiers for new WTRUs added to the sensing task such as WTRU 1040.

In certain representative embodiments, regarding 1014-1020, information related to the newly selected sensing performance profile and the sensing strategy may be included. Such information may include any one or more of a sensing entity specific profile information, information related to the selected sensing topology and sensing mode (e.g., indicating that a given sensing entity may act as either a single transmitter or receiver), or a re-switch strategy (e.g., indicating how long a newly selected sensing topology and sensing mode may be valid for or when to switch to another configuration).

At 1022, the sensing task conforms to the configuration indicated by the newly selected sensing mode and sensing topology. The configuration specifies the sensing performance profiles and switching strategies to be used. If a sensing performance profile is to be switched automatically according to a policy, such policy may indicate the appropriate sensing performance profile to automatically switch to before sensing substantively begins. The configuration may be associated with a time value indicating how long said configuration is valid for. For example, the configuration may be associated with a start and stop time indicating when said configuration should start and stop being used.

At 1024, sensing NF 942 may determine to switch to another sensing mode and sensing topology. When switching to another sensing mode or sensing topology, sensing NF 942 may determine to switch back to the most recent sensing mode and sensing topology configuration. Any changes to secrecy or privacy aspects may be updated as a result of changes to the sensing task.

At 1026 and 1028, sensing NF 924 sends a sensing task termination request to WTRU 1040 or any suitable sensing entity that is to no longer participate in the sensing task.

At 1030 and 1032, sensing NF 924 sends a sensing task update to WTRU 1038 or any suitable sensing entity that is to continue participating in the sensing task. Such an update may indicate information indicative of an updated sensing mode and sensing topology. For example, WTRU 1038 may receive information indicating that the sensing task is to switch from a bi-static mode to a monostatic mode. Such an update may include information indicative of any one or more sensing entities that are to cease participation in the sensing task.

At 1034, the sensing task conforms to the updated configuration. For example, the sensing task no longer includes WTRU 1040 as an active sensing entity, and WTRU 1038 switches its sensing mode to monostatic. If WTRU 1038 is configured to automatically switch its sensing performance profile, the appropriate sensing performance profile may be switched automatically before the updated sensing configuration is supposed to be used henceforth (e.g., before 1034 begins). In certain representative embodiments, sensing NF 924 may notify NF/AF 1038 of the changes made during 1034.

In certain representative embodiments, a sensing entity may be removed from a sensing task. For example, WTRU 1040 may be removed as an active sensing entity as per a decision from sensing NF 924 from 1024. As such, certain permissions and authorizations available to WTRU 1040 may be revoked. The dynamic nature of sensing tasks may make mechanisms for timely revocation or deauthorization of participating sensing entities desirable. Any suitable sensing entity or network function may need to have certain permissions and authorizations revoked as a result of a change in the configuration of a sensing task.

In certain representative embodiments, the security status of a sensing entity itself may necessitate its removal. For example, if WTRU 1038 is suspected of being compromised, exhibits anomalous behavior, or fails to meet updated security protocols, continued participation may introduce vulnerabilities or provide inaccurate data. Furthermore, sensing topology changes within the network or the sensing environment may necessitate adjustments to the set of participating entities to maintain optimal coverage or efficiency. For example, WTRU 1040 may move out of the area determined to be acceptable for a sensing task, a more capable sensor may become newly available, or the network may be reconfigured.

In certain representative embodiments, upon the determination that a sensing entity should be removed, certain permissions and authorizations of said sensing entity may be revoked regarding the corresponding sensing task. As such, the revoked sensing entity may no longer contribute or access data related to that particular sensing activity. The revocation process may be managed and initiated by sensing NF 924 (e.g., at 1024).

In certain representative embodiments, to formally revoke certain permissions and authorizations of a particular sensing entity, sensing NF 924 may communicate with a dedicated NF responsible for sensing entity authentication. Such communication may involve informing an NF configured to perform at least one authentication function with identifying information regarding the sensing entity that needs to be deauthorized for the particular sensing task. The NF configured to perform at least one authentication function may update its records and potentially trigger procedures to invalidate any existing security credentials held by the removed entity for the sensing task.

In certain representative embodiments, sensing NF 924 notifies any suitable management and control plane entities of information indicative of changes in permission and authorization of any suitable one or more sensing entities. For example, sensing NF 924 may notify AMF 934, UPF 936, or any suitable combination thereof that WTRU 1040 was removed from the sensing task. UPF 936 may manage subscription and policy information related to WTRU 1040. Sensing NF 924 may notify a PCF or any suitable policy enforcement function. Such a notification may include information about the one or more revoked sensing entities and the specific sensing task said sensing entities were associated with. Such a notification allows network functions to update their internal states, enforce access control policies, and potentially trigger further actions. Further actions may include releasing resources associated with the removed entity or updating policies for other participating entities.

FIG. 11 is a flowchart of an illustrative method performed by a WTRU for dynamically switching a sensing profile, in accordance with certain embodiments. Such a method is illustrated as method 1100 and includes at least operations 1102-1108 in any suitable order.

At 1102, a WTRU (e.g., which may correspond to any one of WTRUs 102a-102d of FIGS. 1A-1D, WTRU 340 of FIG. 3, WTRU 410 of FIG. 4, WTRUs 508 or 510 of FIG. 5A, WTRUs 556 or 560 of FIG. 5B, WTRU 602 of FIG. 6, WTRU 930 of FIG. 9 or WTRUs 1038 or 1040 of FIG. 10) may receive, from a wireless network, a first sensing profile, a second sensing profile, and sensing capability monitoring information. In certain representative embodiments, 1102 may correspond to 910 or 912 of FIG. 9.

In certain representative embodiments, the first sensing profile is associated with a first sensing configuration, where the first sensing configuration corresponds to a monostatic configuration, a bi-static configuration, or a multi-static configuration. The second sensing profile corresponds to a second sensing configuration that is different from the first sensing configuration. In certain representative embodiments, the first sensing profile is associated with a first quality of service, and the second sensing profile is associated with a second quality of service. In certain representative embodiments, the second sensing profile includes an indication to terminate the sensing task or an indication to perform a different sensing task. As disclosed herein, each of the first sensing profile and the second sensing profile may at least refer to any type of suitable information that the WTRU may use to dictate how it is to perform a sensing task.

At 1104, the WTRU may perform a sensing task based on the first profile. In certain representative embodiments, 1104 may correspond to 916 of FIG. 9 or 1006 of FIG. 10.

At 1106, the WTRU may determine a change in sensing capability based on the sensing capability monitoring information while performing the sensing task. In certain representative embodiments, 1106 may correspond to 916 of FIG. 9 or 1014 or 1016 of FIG. 10. In certain representative embodiments, the sensing capability monitoring information include a request to monitor for changes in sensing capability.

In certain representative embodiments, when determining a change in the sensing capability based on the sensing capability monitoring information while performing the sensing task, the WTRU may perform any one or more of the following: determine a change in hardware functionality of the WTRU, determine a change in software functionality of the WTRU, determine an existence of one or more available frequency channels, determine whether a line of sight condition has changed, determine a change in sensing resolution, determine a change in sensing latency, or determine whether a sensing measurement exceeds a threshold.

At 1108, the WTRU, based on determining the change in the sensing capability, reports, to the wireless network, sensing capability information. The WTRU, based on determining the change in the sensing capability, may further configure itself based on the second sensing profile. In certain representative embodiments, 1108 may correspond to 920 or 922 of FIG. 9 or 1016, 1022, 1032, or 1034 of FIG. 10.

In certain representative embodiments, the sensing capability information includes any one or more of the following: information indicative of types of sensing the WTRU is able to perform, information indicative of whether the WTRU is capable of acting as a transmitter for the sensing task, information indicative of whether the WTRU is capable of acting as a receiver for the sensing task, information indicative of data transmission capabilities, information indicative of a power specification, information indicative of a valid time window, or information indicative of a line of sight condition. In certain representative embodiments, reporting the sensing capability information includes any one or more of aggregating, multiplexing, or sampling of sensing capability information from multiple sources. In certain representative embodiments, the sensing capability monitoring request indicates using one of a control plane or a user plane for reporting the sensing capability information.

In certain representative embodiments, the sensing capability monitoring request indicates a sensing profile switch condition, and the WTRU may, based on determining that the sensing profile switch condition is satisfied, select the second sensing profile for performing the sensing task.

In certain representative embodiments, configuring the WTRU based on the second profile is based on the WTRU receiving, from the wireless network, an indication to select the second sensing profile for performing the sensing task.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term "video" or the term "imagery" may mean any of a snapshot, single image and/or multiple images displayed over a time basis. As another example, when referred to herein, the terms "user equipment" and its abbreviation "UE", the term "remote" and/or the terms "head mounted display" or its abbreviation "HMD" may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit ("CPU") and memory. In accordance with the practices of persons skilled in the art of computer programming, reference to acts and symbolic representations of operations or instructions may be performed by the various CPUs and memories. Such acts and operations or instructions may be referred to as being "executed," "computer executed" or "CPU executed."

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, or any suitable combination thereof. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, or any suitable combination thereof, and a transmission type medium such as a digital and/or an analog communication medium (e.g., a fiber optic cable, a waveguide, a wired communications link, a wireless communication link,.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively "associated" such that the desired functionality may be achieved. Hence, any two components herein combined to achieve a particular functionality may be seen as "associated with" each other such that the desired functionality is achieved, irrespective of architectures or intermedial components. Likewise, any two components so associated may also be viewed as being "operably connected", or "operably coupled", to each other to achieve the desired functionality, and any two components capable of being so associated may also be viewed as being "operably couplable" to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as "open" terms (e.g., the term "including" should be interpreted as "including but not limited to," the term "having" should be interpreted as "having at least," the term "includes" should be interpreted as "includes but is not limited to"). It will be further understood by those within the art that if a specific number of an introduced claim recitation is intended, such an intent will be explicitly recited in the claim, and in the absence of such recitation no such intent is present. For example, where only one item is intended, the term "single" or similar language may be used. As an aid to understanding, the following appended claims and/or the descriptions herein may include usage of the introductory phrases "at least one" and "one or more" to introduce claim recitations. However, the use of such phrases should not be construed to imply that the introduction of a claim recitation by the indefinite articles "a" or "an" limits any particular claim including such introduced claim recitation to embodiments including only one such recitation, even when the same claim includes the introductory phrases "one or more" or "at least one" and indefinite articles such as "a" or "an" (e.g., "a" and/or "an" should be interpreted to mean "at least one" or "one or more"). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of "two recitations," without other modifiers, means at least two recitations, or two or more recitations). Furthermore, in those instances where a convention analogous to "at least one of A, B, and C, etc." is used, in general such a construction is intended in the sense one having skill in the art would understand the convention (e.g., "a system having at least one of A, B, and C" would include but not be limited to systems that have A alone, B alone, C alone, A and B together, A and C together, B and C together, and/or A, B, and C together). In those instances where a convention analogous to "at least one of A, B, or C, etc." is used, in general such a construction is intended in the sense one having skill in the art would understand the convention (e.g., "a system having at least one of A, B, or C" would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase "A or B" will be understood to include the possibilities of "A" or "B" or "A and B." Further, the terms "any of" followed by a listing of a plurality of items and/or a plurality of categories of items, as used herein, are intended to include "any of," "any combination of," "any multiple of," and/or "any combination of multiples of" the items and/or the categories of items, individually or in conjunction with other items and/or other categories of items. Moreover, as used herein, the term "set" is intended to include any number of items, including zero. Additionally, as used herein, the term "number" is intended to include any number, including zero. And the term "multiple", as used herein, is intended to be synonymous with "a plurality".

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, or any suitable combination thereof. As a non-limiting example, each range discussed herein may be readily broken down into a lower third, middle third and upper third, or any suitable combination thereof. As will also be understood by one skilled in the art all language such as "up to," "at least," "greater than" "less than," and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms "means for" in any claim is intended to invoke 35 U.S.C. §112, ¶ 6 or means-plus-function claim format, and any claim without the terms "means for" is not so intended.

What is claimed is:

1. A method performed by a wireless transmit/receive unit (WTRU), comprising:
receiving, from a wireless network, a first sensing profile, a second sensing profile, and sensing capability monitoring information;
performing a sensing task based on the first sensing profile;
determining a change in sensing capability based on the sensing capability monitoring information while performing the sensing task; and
based on determining the change in the sensing capability:
reporting, to the wireless network, sensing capability information; and
configuring the WTRU based on the second sensing profile.

2. The method of claim 1, wherein the sensing capability monitoring information indicates a sensing profile switch condition, the method further comprising:
based on determining that the sensing profile switch condition is satisfied, selecting the second sensing profile for performing the sensing task.

3. The method of claim 1, wherein configuring the WTRU based on the second sensing profile is based on an indication, wherein the indication is received from the wireless network, to select the second sensing profile for performing the sensing task.

4. The method of claim 1, wherein:
the first sensing profile is associated with a first sensing configuration, wherein the first sensing configuration comprises a monostatic configuration, a bi-static configuration, or a multi-static configuration; and
the second sensing profile is associated with a second sensing configuration that is different from the first sensing configuration.

5. The method of claim 1, wherein:
the first sensing profile is associated with a first quality of service; and
the second sensing profile is associated with a second quality of service.

6. The method of claim 1, wherein the second sensing profile comprises an indication to perform a different sensing task.

7. The method of claim 1, wherein determining the change in the sensing capability based on the sensing capability monitoring information while performing the sensing task comprises any one or more of:
determining a change in hardware functionality of the WTRU;
determining a change in software functionality of the WTRU;
determining an existence of one or more available frequency channels;
determining whether a line of sight condition has changed;
determining a change in sensing resolution;
determining a change in sensing latency; or
determining whether a sensing measurement exceeds a threshold.

8. The method of claim 1, wherein the sensing capability information comprises any one or more of:
information indicative of types of sensing the WTRU is able to perform;
information indicative of whether the WTRU is capable of acting as a transmitter for the sensing task;
information indicative of whether the WTRU is capable of acting as a receiver for the sensing task;
information indicative of data transmission capabilities;
information indicative of a power specification;
information indicative of a valid time window; or
information indicative of a line of sight condition.

9. The method of claim 1, wherein reporting the sensing capability information comprises any one or more of aggregating, multiplexing, or sampling of sensing capability information from multiple sources.

10. The method of claim 1, wherein the sensing capability monitoring information indicates using one of a control plane or a user plane for reporting the sensing capability information.

11. A wireless transmit/receive unit (WTRU) comprising processing circuitry and communication circuitry, the WTRU configured to:
receive, from a wireless network, a first sensing profile, a second sensing profile, and sensing capability monitoring information;
perform a sensing task based on the first sensing profile;
determine a change in sensing capability based on the sensing capability monitoring information while performing the sensing task; and
based on determining the change in the sensing capability:
report, to the wireless network, sensing capability information; and
configure the WTRU based on the second sensing profile.

12. The WTRU of claim 11, wherein the sensing capability monitoring information indicates a sensing profile switch condition, the WTRU further configured to:
based on determining that the sensing profile switch condition is satisfied, selecting the second sensing profile for performing the sensing task.

13. The WTRU of claim 11, wherein the WTRU being configured based on the second sensing profile is based on an indication, wherein the indication is received from the wireless network, to select the second sensing profile for performing the sensing task.

14. The WTRU of claim 11, wherein:
the first sensing profile is associated with a first sensing configuration, wherein the first sensing configuration comprises a monostatic configuration, a bi-static configuration, or a multi-static configuration; and
the second sensing profile is associated with a second sensing configuration that is different from the first sensing configuration.

15. The WTRU of claim 11, wherein:
the first sensing profile is associated with a first quality of service; and
the second sensing profile is associated with a second quality of service.

16. The WTRU of claim 11, wherein the second sensing profile comprises an indication to perform a different sensing task.

17. The WTRU of claim 11, wherein, when determining the change in the sensing capability based on the sensing capability monitoring information while performing the sensing task, the WTRU is further configured to:
determine a change in hardware functionality of the WTRU;
determining a change in software functionality of the WTRU;
determine an existence of one or more available frequency channels;
determine whether a line of sight condition has changed;
determine a change in sensing resolution;
determine a change in sensing latency; or
determine whether a sensing measurement exceeds a threshold.

18. The WTRU of claim 11, wherein the sensing capability information comprises any one or more of:
information indicative of types of sensing the WTRU is able to perform;
information indicative of whether the WTRU is capable of acting as a transmitter for the sensing task;
information indicative of whether the WTRU is capable of acting as a receiver for the sensing task;
information indicative of data transmission capabilities;
information indicative of a power specification;
information indicative of a valid time window; or
information indicative of a line of sight condition.

19. The WTRU of claim 11, wherein reporting the sensing capability information comprises any one or more of aggregating, multiplexing, or sampling of sensing capability information from multiple sources.

20. The WTRU of claim 11, wherein the sensing capability monitoring information indicates using one of a control plane or a user plane for reporting the sensing capability information.
